(19) United States
(12) Patent Application Publication
(10) Pub. No.: US 2007/0049678 A1
(43) Pub. Date: Mar. 1, 2007

(54) Thermoplastic nanocomposite resin composite materials

(76) Inventors: Il Jin Kim, Gunpo-si (KR); Ho Joo, Seoul (KR); Dong Wook Jeong, Yeosu-si (KR); Soon Kun Kang, Seongnam-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/487,794

(22) Filed: Jul. 17, 2006

Related U.S. Application Data
(63) Continuation-in-part of application No. PCT/KR05/04496, filed on Dec. 23, 2005.

(30) Foreign Application Priority Data
Aug. 24, 2005 (KR) 10-2005-0077955

(51) Int. Cl. C08K 3/22

(52) U.S. Cl. 524/430

(57) ABSTRACT

A polymer composite material includes metal (oxide) nanoparticles adsorbed on the surface of a rubber-modified graft copolymer. Some embodiments may additionally comprise a thermoplastic resin in which the nanoparticles and rubber-modified graft copolymer are dispersed. In some embodiments, the composite materials have improved impact strength, tensile strength, heat resistance, and flexural modulus.

### CROSS-REFERENCE TO RELATED APPLICATIONS

This application is a continuation-in-part application under 35 U.S.C. § 365(c) claiming the benefit of the filing date of PCT Application No. PCT/KR2005/004496 designating the United States, filed Dec. 23, 2005. The PCT Application claims the benefit of the earlier filing date of Korean Patent Application No. 10-2005-0077955, filed Aug. 24, 2005. The contents of the PCT Application and Korean Patent Application No. 10-2005-0077955 are incorporated herein by reference in their entirety.

### BACKGROUND OF THE INVENTION

1. Field of the Invention

The present invention relates to nanoparticles in combination with polymers.

2. Description of the Related Art

Thermoplastic resins are widely used because of their light weight and excellent moldability. However, thermoplastic resins may have poor thermal resistance, abrasion resistance and rigidity. In recent years, there has been a continuing effort to develop thermoplastic materials with improved physical properties. Specifically, research has focused on the creation of a highly moldable thermoplastic resin with good thermal resistance, abrasion resistance, modulus and rigidity.

One method of improving mechanical properties of thermoplastic resins includes adding inorganic fillers such as glass fiber, talc, and mica. However, resin composite materials prepared by blending inorganic filler and a thermoplastic resin lack a sufficient reinforcing effect because the bonding strength between the inorganic filler and the matrix resin is weak. Further, large amounts of inorganic filler may cause serious deterioration of impact strength.

In recent years, research has also focused on the effects of metal nanoparticles on different materials. Dispersion of very small metal particles in polymeric matrices is scientifically and technologically important for a variety of reasons. The preparation of nanoscale materials with unique properties represents a significant challenge. One potential advantage of a dispersed particle system is that many of its properties are strongly dependent on the interfacial properties of the materials because the fraction of the overall materials, which is in the vicinity of the fraction of an interface, is quite high. In addition to simply providing a large interfacial area, dispersions of very small inorganic particles may have useful electronic, optical, magnetic, chemical, catalytic and unique mechanical properties.

### SUMMARY OF THE INVENTION

Described herein are composite materials comprising metal (oxide) nanoparticles and a rubber-modified graft copolymer. In some particular embodiments, the metal (oxide) nanoparticles are colloidal. In some embodiments, the composite material comprises about 0.1 to about 50 parts by weight of the nanoparticles, based on the rubber-modified graft copolymer totaling about 100 parts by weight.

In some embodiments, the metal (oxide) nanoparticles are adsorbed on a surface of the rubber-modified graft copolymer. In some embodiments, the colloidal metal (oxide) nanoparticles are dispersed in the rubber-modified graft copolymer. In particular embodiments, the colloidal metal (oxide) nanoparticles are not covalently bonded to the rubber-modified graft copolymer. Instead, the nanoparticles and the rubber-modified graft copolymer are physically adhered through other molecular interactions such as hydrogen bonding, ion interactions, polar interactions, and Van der Waals interactions.

In some embodiments, the rubber-modified graft copolymer is a graft copolymer of a rubber polymer and one or more monomers bonded to the rubber polymer. In some embodiments, the one or more monomers bonded to the rubber polymer are selected from the group consisting of an aromatic vinyl compound and a vinyl cyanide compound. In some of the foregoing embodiments, the aromatic vinyl compound and the vinyl cyanide compound form a polymer which is bonded to the rubber polymer.

In some embodiments, the nanoparticles have an average particle size from about 5 nm to about 300 nm. In other embodiments, the nanoparticles have an average particle size from about 5 to about 100 nm.

In some embodiments the composite material additionally comprises a thermoplastic resin. In some embodiments, the rubber-modified graft copolymer and the metal (oxide) nanoparticles are dispersed in a matrix of the thermoplastic resin. Such a dispersion may provide enhanced physical and mechanical properties to the thermoplastic resin as further described herein. In some embodiments, the thermoplastic resin comprises one or more selected from acrylonitrile-butadiene-styrene copolymer (ABS); acrylonitrile-acrylic rubber styrene copolymer resin (AAS), acrylonitrile-ethylenepropylene rubber-styrene copolymer resin, and acrylonitrile-styrene copolymer (SAN) resin. In one particular embodiment, the thermoplastic resin is a SAN resin.

In some embodiments, the composite material, including the rubber modified graft copolymer, the metal (oxide) nanoparticles, and the thermoplastic resin, has impact strength greater than or equal to about 21 kgf.cm/cm when a specimen of the material is tested under the standard ASTM D-256 (¼″ notched) at 23° C. In some of these embodiments, the composite material has impact strength greater than or equal to about 23 kgf.cm/cm when a specimen of the material is tested under the standard ASTM D-256 (¼″ notched) at 23° C.

In other embodiments, the composite material, including the rubber modified graft copolymer, the metal (oxide) nanoparticles, and the thermoplastic resin, has impact strength greater than or equal to about 40 kgf.cm/cm when a specimen of the material is tested under the standard ASTM D-256 (⅛″ notched) at 23° C. In some of these embodiments, the composite material has impact strength greater than or equal to about 45 kgf.cm/cm when a specimen of the material is tested under the standard ASTM D-256 (⅛″ notched) at 23° C.

In some embodiments, the composite material, including the rubber modified graft copolymer, the metal (oxide) nanoparticles, and the thermoplastic resin, has tensile strength of greater than or equal to about 501 kgf/cm² when a specimen of the material is tested under the standard ASTM D638 (5 mm/min). In some embodiments, the composite material has tensile strength of greater than or equal to about 525 kgf/cm² when a specimen of the material is tested under the standard ASTM D638 (5 mm/min). In some embodiments, the composite material has tensile strength of greater than or equal to about 530 kgf/cm² when a specimen of the material is tested under the standard ASTM D638 (5 mm/min).

In some embodiments, the composite material, including the rubber modified graft copolymer, the metal (oxide) nanoparticles, and the thermoplastic resin, has flexural modulus of greater than or equal to about 24200 kgf/cm² when a specimen of the material is tested under the standard ASTM D790 (¼″). In some embodiments, the composite material has flexural modulus of greater than or equal to about 25100 kgf/cm² when a specimen of the material is tested under the standard ASTM D790 (¼″). In some embodiments, the composite material has flexural modulus of greater than or equal to about 25500 kgf/cm² when a specimen of the material is tested under the standard ASTM D790 (¼″).

In some embodiments, the composite material, including the rubber modified graft copolymer, the metal (oxide) nanoparticles, and the thermoplastic resin, has Heat Distortion Temperature of greater than or equal to about 90° C. when a specimen of the material is tested under the standard ASTM D648 (¼″, 120° C./hr) under 18.5 kgf/cm² load. In some embodiments, the composite material has Heat Distortion Temperature of greater than or equal to about 91° C. when a specimen of the material is tested under the standard ASTM D648 (¼″, 120° C./hr) under 18.5 kgf/cm² load.

An additional embodiment includes a molded article comprising the composite material as described herein. Another embodiment includes an electronic device comprising the composite materials as described herein.

Methods of preparing the composite materials are also described herein. One embodiment is a method of preparing a nanocomposite material comprising providing a rubber-modified graft copolymer, providing colloidal metal (oxide) nanoparticles, adsorbing the colloidal metal (oxide) nanoparticles on a surface of the rubber-modified graft copolymer to provide a nanoparticle/graft copolymer latex.

In some embodiments, the rubber-modified graft copolymer and the colloidal metal (oxide) nanoparticles are mixed by in-situ stirring.

In some embodiments, the method further comprises dehydrating the nanoparticle/graft copolymer latex, and drying the nanoparticle/graft copolymer latex. In certain embodiments, the method may also comprise agglomerating the nanoparticle/graft copolymer latex, dehydrating the nanoparticle/graft copolymer latex; and drying the nanoparticle/graft copolymer latex.

### BRIEF DESCRIPTION OF THE DRAWINGS

FIG. 1 is a transmission electron micrograph (TEM) of the composite material obtained in Example 1.

### DETAILED DESCRIPTION OF THE PREFERRED EMBODIMENT

As noted above, one aspect of this invention relates to a polymer composite material. According to various embodiments, the polymer composite material comprises a rubber-modified graft polymer and nanoparticles. In some embodiments, the nanoparticles are metal (oxide) nanoparticles. In some embodiments, the nanoparticles are colloidal nanoparticles. In particular embodiments, the nanoparticles are physically adhered to the surface of the rubber-modified graft copolymer. In some embodiments, the nanoparticles are adsorbed on the surface of the rubber-modified graft copolymer. Additional embodiments of the composite material also comprise a thermoplastic resin. Shaped articles comprising the composite material of the embodiments show enhanced physical or mechanical properties as compared to other composite materials less one or more components. The shaped articles of the embodiments also demonstrate improved impact strength, tensile strength, flexural modulus, and heat distortion temperatures over composite materials less one or more components. In addition to improved physical or mechanical properties, some embodiments also possess transparency and moldability. Additional advantages of some embodiments also include a low thermal expansion coefficient and good abrasion resistance.

In some embodiments, a composite material comprises a rubber-modified graft copolymer and metal (oxide) nanoparticles. As used herein, “metal (oxide) nanoparticles” may refer to both metal nanoparticles and/or metal oxide nanoparticles.

In some embodiments, at least a portion of the nanoparticles of the composite material are adsorbed on the surface of the rubber-modified graft copolymer. In some embodiments, the adsorption occurs through a physical interaction such as van der Waals interactions or hydrogen bonding.

In certain of these embodiments, the composite material comprises about 100 parts by weight of a rubber-modified graft copolymer and about 0.1 to about 50 parts by weight of colloidal metal (oxide) nanoparticles. In some embodiments, the colloidal metal (oxide) nanoparticles comprise about 0.1, 0.3, 0.5, 0.7, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50 parts by weight of the composite material, based on 100 parts by weight of the rubber-modified graft copolymer.

In addition, some embodiments of the composite material additionally comprise a thermoplastic resin, such as a rubber-modified graft copolymer or a vinyl copolymer. In some embodiments, inorganic nanoparticles are uniformly dispersed in a thermoplastic resin matrix by introducing colloidal metal (oxide) nanoparticles before or after polymerization. In some embodiments, physical bonding between the functional group on the surface of the nanoparticles and the thermoplastic resin is induced, so that the thermoplastic nanocomposite resin composition has improved impact resistance and mechanical strength, as well as good thermal resistance. In certain embodiments, the composite material comprises about 60 to about 90 parts by weight of the thermoplastic resin and about 10 to about 40 parts by weight of the nanoparticle/rubber-modified graft copolymer moiety. These components are further described herein.

Certain thermoplastic nanocomposite resin composite materials described herein have a reduced content of inorganic filler as compared to those using convention dispersions. In some of these embodiments, the specific gravity of the nanocomposite is reduced.

These components are further described herein.

Rubber-Modified Graft Copolymer

In one embodiment, the rubber-modified graft copolymer is a polymer of one or more monomers and/or polymers. In particular embodiments, the rubber-modified graft copolymer comprises a rubber polymer core to which vinyl monomers and/or vinyl polymers are grafted. In one embodiment, the rubber-modified graft copolymer is a polymer of a rubber polymer and one or more monomers selected from aromatic vinyl compounds and vinyl cyanide compounds.

In some embodiments, the rubber-modified graft copolymer is a polymer of about 25 to about 70 parts by weight of a rubber polymer, about 40 to about 90 parts by weight of an aromatic vinyl compound, and about 10 to about 60 parts by weight of a vinyl cyanide compound.

In some embodiments, the rubber polymer is selected from one or more of a diene rubber, an ethylene rubber, an ethylene-propylene-diene terpolymer (EPDM).

In some embodiments, the aromatic vinyl compound is selected from one or more of styrene, α-methylstyrene, β-methylstyrene, o-methylstyrene, m-methylstyrene, p-methylstyrene, o-ethylstyrene, m-ethylstyrene, p-ethylstyrene, o-tert-butylstyrene, m-tert-butylstyrene, p-tert-butylstyrene, o-chlorostyrene, m-chlorostyrene, p-chlorostyrene, dichlorostyrene, o-bromostyrene, m-bromostyrene, p-bromostyrene, dibromostyrene, vinyl toluene, vinyl xylene, vinyl naphthalene, and divinylbenzene.

In some embodiments, the vinyl cyanide compound is selected from one or more of acrylonitrile, methacrylonitrile, and ethacrylonitrile.

In some embodiments, the graft-polymerization is conducted according to emulsion polymerization or suspension polymerization. In one embodiment, the rubber-modified graft copolymer may be prepared as a latex dispersion in water (optionally treated by ion exchange to remove any metals). In some embodiments, the graft copolymer latex may be prepared via graft polymerization employing seed rubber latex obtained from conventional emulsion polymerization.

In some embodiments, the particle size of the graft copolymer latex is from about 800 to about 4000 Å. In some embodiments, the solid content of the graft copolymer latex may be from about 20 to about 50 parts by weight. In other embodiments, the solid content is about 30 to about 40 parts by weight.

Metal (Oxide) Nanocomposite Material

In some embodiments, a composite material comprises a rubber-modified graft copolymer as described herein and colloidal metal (oxide) nanoparticles. In some embodiments, the colloidal metal (oxide) nanoparticles are adsorbed onto the surface of the rubber-modified graft copolymer.

In some embodiments, the nanocomposite material may be prepared by adding colloidal metal (oxide) nanoparticles to a rubber-modified graft copolymer thereby adsorbing the nanoparticles onto a surface of the rubber-modified graft copolymer to form a graft copolymer-nanoparticle composite latex. The latex may then by dehydrated and dried. If desired, the graft copolymer-nanoparticle composite latex may be agglomerated with an agglomerating agent prior to the dehydrating and drying step.

In one embodiment, the rubber-modified graft copolymer is prepared as a water-dispersed latex. In some embodiments, the water-dispersed latex and colloidal metal (oxide) nanoparticles may be mixed by in-situ stirring.

In another embodiment, the graft copolymer-nanoparticle composite may be obtained through in-situ stirring by preparing the rubber-modified graft copolymer latex, adding the colloidal metal (oxide) nanoparticles to form a graft copolymer-nanoparticle composite latex, and agglomerating the graft copolymer-nanoparticle composite latex with an agglomerating agent.

In some embodiments, the pH range of the graft copolymer latex may be adjusted to achieve good dispersion stability of the nanoparticles in the rubber-modified graft copolymer. In some embodiments, the colloidal metal (oxide) nanoparticles have good dispersion stability at a pH range of about 8 to about 11. In some embodiments, the colloidal metal (oxide) nanoparticles have a dispersion stability of about 1 to about 5. Furthermore, the pH may be controlled in the desired range after the addition of the colloidal metal (oxide) nanoparticles to the rubber-modified graft copolymer latex.

In some embodiments, the colloidal metal (oxide) nanoparticles are added to the graft copolymer latex in a dropwise manner with sufficient stirring to minimize coagulation and to increase the dispersion of the nanoparticles in the graft copolymer latex. After the addition of the colloidal metal (oxide) nanoparticles is completed, the mixture may be further stirred for about 5 to about 30 minutes. In some embodiments, the mixing of the colloidal metal (oxide) nanoparticles and the graft copolymer latex is conducted at room temperature. In other embodiments, the mixing is conducted in a temperature range from about 50° C. to about 80° C.

The graft copolymer-metal (oxide) nanoparticle latex may be agglomerated by means of an agglomerating agent, then dehydrated and dried to obtain a graft copolymer-nanoparticle composite in powder form. An aqueous solution of an acid or metal salt, including, but not limited to, one or more selected from sulfuric acid, hydrochloric acid, magnesium chloride, calcium chloride, magnesium sulfate, calcium sulfate, can be used as the agglomerating agent. In some embodiments, the pH of the aqueous solution of the agglomerating agent is preferably about 1 to about 5.

The particular colloidal metal (oxide) nanoparticles may include, but are not limited to, one or more metal oxides such as silicon dioxide (SiO₂), aluminum oxide (Al₂O₃), titanium dioxide (TiO₂), tin oxide (SnO₂), iron oxide (Fe₂O₃), zinc oxide (ZnO), magnesium oxide (MgO), zirconium oxide (ZrO₂), cerium oxide (CeO₂), lithium oxide (Li₂O), and silver oxide (AgO). The colloidal metal (oxide) nanoparticles may also include, but are not limited to, one or more metals such as silver (Ag), nickel (Ni), magnesium (Mg), and zinc (Zn). In some embodiments, one or more metal and metal oxides may be used in combination.

In some embodiments, colloidal metal (oxide) nanoparticles have an average particle size from about 5 nm to about 300 nm, preferably from about 5 nm to about 100 nm.

In one embodiment, the colloidal metal (oxide) nanoparticles are stabilized with an acid having a pH of about 1 to about 5. In another embodiment, the colloidal metal (oxide) nanoparticles have a pH range of about 8 to about 11.

In some embodiments, the colloidal metal (oxide) nanoparticles may be adjusted through the use of various amounts of counter ions. For example, metal salts or metal ions may be added to the cationic or anionic colloidal metal (oxide) nanoparticles. In some embodiments, the counter ions may control certain properties of the colloidal nanoparticles or the thermoplastic resin as mixed with the nanocomposite material.

Thermoplastic Resin Composite Materials

As described above, the composite material may further comprise a thermoplastic resin. In some embodiments, the thermoplastic resin is a rubber-modified graft copolymer. Examples of suitable thermoplastic resins that can be used in combination with the metal (oxide) nanocomposite material as described herein includes, but is not limited to, acrylonitrile-butadiene-styrene copolymer (ABS), acrylonitrile-acrylic rubber-styrene copolymer resin (AAS), acrylonitrile-ethylenepropylene rubber-styrene copolymer resin, acrylonitrile-styrene copolymer resin (SAN).

In one embodiment, the thermoplastic resin may be obtained by polymerizing about 40 to about 90 parts by weight of an aromatic vinyl compound and about 10 to about 60 parts by weight of a vinyl cyanide compound. In the aforementioned embodiment, the aromatic vinyl compound may be one or more selected from the group consisting of styrene, α-methylstyrene, β-methylstyrene, o-methylstyrene, m-methylstyrene, p-methylstyrene, o-ethylstyrene, m-ethylstyrene, p-ethylstyrene, o-tert-butylstyrene, m-tert-butylstyrene, p-tert-butylstyrene, o-chlorostyrene, m-chlorostyrene, p-chlorostyrene, dichlorostyrene, o-bromostyrene, m-bromostyrene, p-bromostyrene, dibromostyrene, vinyl toluene, vinyl xylene, vinyl naphthalene, and divinylbenzene. In some embodiments, the vinyl cyanide compound includes, but is not limited to, one or more selected from acrylonitrile, methacrylonitrile, and ethacrylonitrile.

The thermoplastic resin of the aforementioned embodiments may optionally include another vinyl monomer that is copolymerizable with one or more of the aromatic vinyl compound and the vinyl cyanide compound. In one embodiment, about 10 to about 60 parts by weight of the optional vinyl monomer is used in the thermoplastic resin. In some embodiments, the optional vinyl monomer may be selected from one or more of methacrylic acid ester, maleimide, and acrylimide.

In some embodiments, the composite material comprises about 10 to about 40 parts by weight of the metal (oxide) nanocomposite material and about 60 to about 90 parts by weight of the thermoplastic resin. In some embodiments, the composite material comprises about 0.1, 0.5, 1, 1.5, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 and 50 parts by weight of the metal (oxide) nanocomposite. In some of these embodiments, the composite material also comprises about 50, 52, 54, 56, 58, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91 92, 93, 94, and 95 parts by weight of the thermoplastic resin.

Additional Components

Composite material mixtures may additionally comprise one or more other additives such as surfactants, nucleating agents, coupling agents, fillers, plasticizers, impact modifiers, blending agents, heat-stabilizers, antioxidants, release agents, ultraviolet absorbing agents, stabilizers (e.g. light stabilizers), flame retardants, lubricants, colorants such as dyes and pigments, antistatic agents, flame retardants and small amounts of various polymers. The composite materials can contain one or more compounds or polymers in addition to the foregoing components. Additional components or additives may be added to provide additional properties or characteristics to the composite material or to modify existing properties of the composite material. One of ordinary skill in the art will appreciate that various additives may be added to the composite materials according to some embodiments.

Properties of the Composite Materials

An advantage of certain embodiments is to provide a thermoplastic resin composite material with improved physical and mechanical properties. Such properties include, but are not limited to, flexural strength, impact strength, tensile strength, and heat resistance.

Some embodiments comprising metal (oxide) nanoparticles, a rubber-modified graft copolymer in which the metal (oxide) nanoparticles are dispersed, and a thermoplastic resin have impact strength of great than or equal to about 21 kgf.cm/cm, more preferably greater than or equal to about 23 kgf.cm/cm, and even more preferably greater than or equal to about 24 kgf.cm/cm, when a specimen of the composite material is tested according to the standard ASTM D256 (¼″ notched) at 23° C.

Some embodiments comprising metal (oxide) nanoparticles, a rubber-modified graft copolymer in which the metal (oxide) nanoparticles are dispersed, and a thermoplastic resin have impact strength of greater than or equal to about 40 kgf.cm/cm, more preferably greater than or equal to about 42 kgf.cm/cm, and even more preferably greater than or equal to about 45 kgf.cm/cm, when a specimen of the composite material is tested according to the standard ASTM D256 (⅛″ notched) at 23° C.

Some embodiments comprising metal (oxide) nanoparticles, a rubber-modified graft copolymer in which the metal (oxide) nanoparticles are dispersed, and a thermoplastic resin have a tensile strength of greater than or equal to about 501 kgf/cm², more preferably greater than or equal to about 520 kgf/cm², and even more preferably greater or equal to about 530 kgf/cm² when a specimen of the material is tested under the standard ASTM D638 (5 mm/min).

Some embodiments comprising metal (oxide) nanoparticles, a rubber-modified graft copolymer in which the metal (oxide) nanoparticles are dispersed, and a thermoplastic resin have flexural modulus of greater than or equal to about 24200 kgf/cm², more preferably greater than or equal to about 25100 kgf/cm², or even more preferably greater than or equal to about 25500 kgf/cm² when a specimen of the material is tested under the standard ASTM D790 (¼″).

Some embodiments comprising metal (oxide) nanoparticles, a rubber-modified graft copolymer in which the metal (oxide) nanoparticles are dispersed, and a thermoplastic resin have a Heat Distortion Temperature of greater than or equal to about 90° C., more preferably greater than or equal to about 91° C., or even more preferably greater than or equal to about 92° C., when a specimen of the material is tested under the standard ASTM D648 (¼″, 120° C./hr) under 18.5 kgf/cm² load.

Shaped Articles

A shaped article can be made using the composite material according to the foregoing embodiments. In some embodiments, this article is molded into various shapes. An extrusion molding machine such as a vented extruder may be used. The polymer composite material of embodiments may be molded into various moldings using, for example, a melt-molding device. In embodiments, the polymer composite material is formed into a pellet, which then may be molded into various shapes using, for example, injection molding, injection compression molding, extrusion molding, blow molding, pressing, vacuum forming or foaming. In one embodiment, the polymer composite material can be made into a pellet using melt-kneading, and the resulting pellets are molded into moldings through injection molding or injection compression molding.

As noted, in one embodiment, the polymer composite materials are formed into pellets. In other embodiments, the polymer composite materials are formed into structural parts of various consumer products, including electronic devices and appliances. In some embodiments, the polymer composite materials are molded into a housing or body of electronic or non-electronic devices. Examples of electrical devices, in which a molded article made of the blend of the composite material according to embodiments of the invention are used, include printers, computers, word processors, keyboards, personal digital assistants (PDA), telephones, mobile phones, cameras, facsimile machines, copy machines, electronic cash registers (ECR), desk-top electronic calculators, PDAs, cards, stationery holders, washing machines, refrigerators, vacuum cleaners, microwave ovens, lighting equipment, irons, TV, VTR, DVD players, video cameras, radio cassette recorders, tape recorders, mini disc players, CD players, speakers, liquid crystal displays, MP3 players, and electric or electronic parts and telecommunication equipment, such as connectors, relays, condensers, switches, printed circuit boards materials, coil bobbins, semiconductor sealing materials, electric wires, cables, transformers, deflecting yokes, distribution boards, clocks, watches, and the like.

Another embodiment provides an electronic device which includes a housing or a part, which is made of a polymer composite material comprising a composite material as herein described. Some embodiments provide a method of making an electronic device, comprising providing an electrical circuit, providing a housing comprising a portion, and enclosing at least part of the electrical circuit with the housing, wherein the portion comprises embodiments of the composite material as herein described.

The invention is further described in terms of the following examples which are intended for the purpose of illustration and not to be construed as in any way limiting the scope of the present invention, which is defined by the claims. In the following examples, all parts and percentage are by weight unless otherwise indicated.

### EXAMPLES

Each component of (A) rubber-modified graft copolymer, (B) colloidal metal (oxide) nanoparticles, (C) rubber-modified graft copolymer/metal (oxide) nanoparticle composite, (D) copolymer of vinyl cyanide compound and aromatic vinyl compound, (E) fumed silica and (F) silicone impact modifier used in Examples and Comparative Examples was prepared as follows:

(A) Rubber-Modified Graft Copolymer (g-ABS resin)

A rubber-modified graft copolymer was prepared using 50 parts by weight of polybutadiene, 15 parts by weight of acrylonitrile and 35 parts by weight of styrene.

(B) Colloidal Metal (oxide) Nanoparticles

(b₁) Colloidal silica sol having an average particle size of 20 nm and containing less than 0.35% by weight of Na₂O at pH 8-11 was used.

(b₂) Colloidal silica sol having an average particle size of 40-60 nm and containing less than 0.35% by weight of Na₂O at pH 8-11 was used.

(b₃) Colloidal silica sol having an average particle size of 70-100 nm and containing less than 0.35% by weight of Na₂O at pH 8-11 was used.

(C) Rubber-Modified Graft Copolymer/Metal oxide Nanoparticle Composite

(c₁) 5 parts by weight of the colloidal silica nanoparticles (b₁) was added to 95 parts by weight of the rubber-modified graft copolymer (A) latex thereby adsorbing the nanoparticles onto a surface of the rubber-modified graft copolymer, followed by agglomerating, dehydrating and drying to obtain rubber-modified graft copolymer/silica nanoparticles composite in powder form.

(c₂) Nanoparticle composite was prepared in the same manner as the nanoparticle composite (c₁) except that 8 parts by weight of the colloidal silica nanoparticles (b₁) was added to 92 parts by weight of the rubber-modified graft copolymer (A) latex.

(c₃) Nanoparticle composite was prepared in the same manner as the nanoparticle composite (c₁) except that 5 parts by weight of the colloidal silica nanoparticles (b₂) was added to 95 parts by weight of the rubber-modified graft copolymer (A) latex.

(c₄) Nanoparticle composite was prepared in the same manner as the nanoparticle composite (c₁) except that 8 parts by weight of the colloidal silica nanoparticles (b₂) was added to 92 parts by weight of the rubber-modified graft copolymer (A) latex.

(c₅) Nanoparticle composite was prepared in the same manner as the nanoparticle composite (c₁) except that 5 parts by weight of the colloidal silica nanoparticles (b₃) was added to 95 parts by weight of the rubber-modified graft copolymer (A) latex.

(c₆) Nanoparticle composite was prepared in the same manner as the nanoparticle composite (c₁) except that 8 parts by weight of the colloidal silica nanoparticles (b₃) was added to 92 parts by weight of the rubber-modified graft copolymer (A) latex.

(D) Thermoplastic Resin

For the thermoplastic resin, a copolymer of a vinyl cyanide compound and an aromatic vinyl compound was used. SAN copolymer polymerized with 30 parts by weight of acrylonitrile and 70 parts by weight of styrene, and having a weight average molecular weight of 120,000 was used.

(E) Fumed Silica (not Colloidal Silica)

Fumed silica having an average particle size of 5-20 nm was used.

(F) Silicone Impact Modifier

Dimethyl polysiloxane having a molecular weight of 1,000-5,000 was used.

### Examples 1-6

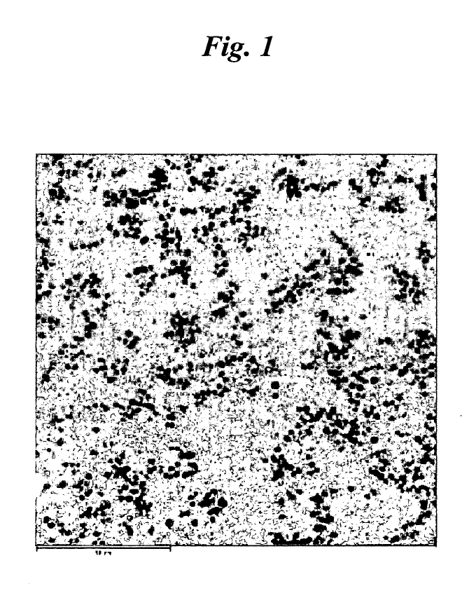

The components as shown in Table 1 were mixed and the mixture was melted and extruded through a twin screw extruder with L/D=29 and Φ=45 mm in pellets. The cylinder temperature of the extruder was kept at 220° C. The pellets were dried at 80° C. for 6 hours. The dried pellets were molded into test specimens using a 6 oz injection molding machine at molding temperature of 240-280° C., and barrel temperature of 60-80° C. The transmission electron micrograph (TEM) of a thermoplastic nanocomposite resin obtained in Example 1 is shown in FIG. 1. As shown in FIG. 1, the nanoparticles are uniformly dispersed throughout the matrix.

### Comparative Examples 1-2

Comparative Examples 1 and 2 were made in the same manner as in Example 1 except that the rubber-modified graft copolymer (A) was used instead of the rubber-modified graft copolymer/metal oxide nanoparticle composite (C)

### Comparative Example 3

Comparative Example 3 was made by simply blending the rubber-modified graft copolymer (A), colloidal silica sol (b₁) and SAN copolymer (D). Also, the rubber-modified graft copolymer/metal oxide nanoparticle composite (C) was not used.

### Comparative Example 4

Comparative Example 4 was conducted by blending that the rubber-modified graft copolymer (A), SAN copolymer (D) and fumed silica (E) were blended. Also, the rubber-modified graft copolymer/metal oxide nanoparticle composite (C) was not used.

TABLE 1

| | | | (B) | | | | | | | | | |
|---|---|---|---|---|---|---|---|---|---|---|---|---|
| | | (A) | (b₁) | | | | | | | | (E) | (F) |
| Specimen | | g-ABS | colloidal | (C)nanoparticle composite | | | | | | | fumed | impact |
| Descriptions | | resin | silica | (c₁) | (c₂) | (c₃) | (c₄) | (c₅) | (c₆) | (D)SAN | silica | modifier |
| Example | 1 | — | — | 25 | — | — | — | — | — | 75 | — | — |
| | 2 | — | — | — | 25 | — | — | — | — | 75 | — | — |
| | 3 | — | — | — | — | 25 | — | — | — | 75 | — | — |
| | 4 | — | — | — | — | — | 25 | — | — | 75 | — | — |
| | 5 | — | — | — | — | — | — | 25 | — | 75 | — | — |
| | 6 | — | — | — | — | — | — | — | 25 | 75 | — | — |
| Comparative | 1 | 25 | — | — | — | — | — | — | — | 75 | — | — |
| Example | 2 | 25 | — | — | — | — | — | — | — | 75 | — | 0.02 |
| | 3 | 25 | 2.0 | — | — | — | — | — | — | 75 | — | — |
| | 4 | 25 | — | — | — | — | — | — | — | 75 | 2.0 | — |

The physical properties of the test specimens of Examples 1-6 and Comparative Examples 1-4 were measured as follows:

(1) Notch Izod Impact Strength: The notch Izod impact strength was measured in accordance with ASTM D256 (¼″, ⅛″, 23° C.).

(2) Tensile Strength: The tensile strength was determined in accordance with ASTM D638 (5 mm/min).

(3) Flexural Modulus: the flexural modulus was measured in accordance with ASTM D790 (¼″).

(4) Heat Distortion Temperature(HDT): The heat distortion temperature was measured according to ASTM D648 (¼″, 120° C./hr) under 18.5 kgf/cm².

The test results are shown in Table 2.

TABLE 2

| | | Notched Izod | | | | |
|---|---|---|---|---|---|---|
| | | Impact Strength | | Tensile | Flexural | |
| Specimen | | (Kgf · cm/cm) | | Strength | Modulus | HDT |
| Descriptions | | ¼″ | ⅛″ | (Kgf/cm²) | (Kgf/cm²) | (° C.) |
| Example | 1 | 24 | 42 | 501 | 24200 | 90 |
| | 2 | 21 | 40 | 520 | 25100 | 92 |
| | 3 | 23 | 45 | 525 | 24800 | 91 |
| | 4 | 25 | 46 | 530 | 25600 | 92 |
| | 5 | 21 | 40 | 525 | 24700 | 90 |
| | 6 | 23 | 43 | 536 | 25500 | 91 |
| Compara- | 1 | 18 | 26 | 500 | 23100 | 88 |
| tive | 2 | 24 | 41 | 465 | 22000 | 88 |
| Example | 3 | 17 | 23 | 488 | 22500 | 88 |
| | 4 | 16 | 22 | 475 | 22700 | 88 |

As shown in Table 2, the thermoplastic nanocomposite resin compositions of Examples 1-6 excellent impact strength as well as good tensile strength and flexural modulus compared to those not employing rubber-modified graft copolymer/silica nanoparticle composite. Further, resin compositions using larger sized colloidal silica nanoparticles show higher mechanical strength than those using particles having a smaller size.

Comparative Example 2 employing a silicone impact modifier had deteriorated tensile strength and flexural modulus. Comparative Example 3, in which rubber-modified graft copolymer (A), colloidal silica sol (b₁) and SAN copolymer (D) were blended without using the in-situ method as described in Examples 1-6, had degraded impact strength, tensile strength and flexural modulus. Comparative Example 4 which employed filmed silica instead of colloidal silca also had deteriorated properties. It is apparent that the physical properties of the thermoplastic nanocomposite resin compositions as described herein may be controlled by adjusting the size and amount of metal (oxide) nanoparticles.

The skilled artisan will recognize the interchangeability of various features from different embodiments. Similarly, the various features and steps discussed above, as well as other known equivalents for each such feature or step, can be mixed and matched by one of ordinary skill in this art to perform composite materials or methods in accordance with principles described herein. Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of embodiments herein. Rather, the scope of the present invention is to be interpreted with reference to the claims that follow.

What is claimed is:

1. A composite material comprising:
about 100 parts by weight of a rubber-modified graft copolymer; and
about 0.1 to about 50 parts by weight colloidal metal (oxide) nanoparticles.

2. The composite material of claim 1, wherein the colloidal metal (oxide) nanoparticles are adsorbed on a surface of the rubber-modified graft copolymer.

3. The composite material of claim 1, wherein the colloidal metal (oxide) nanoparticles are dispersed in the rubber-modified graft copolymer.

4. The composite material of claim 1, wherein the colloidal metal (oxide) nanoparticles are not covalently bonded to the rubber-modified graft copolymer.

5. The composite material of claim 1, wherein the rubber-modified graft copolymer is a graft copolymer of a rubber polymer and one or more monomers bonded to the rubber polymer, wherein the one or more monomers are selected from the group consisting of an aromatic vinyl compound and a vinyl cyanide compound.

6. The composite material of claim 5, wherein a polymer comprising the aromatic vinyl compound and the vinyl cyanide compound is bonded to the rubber polymer.

7. The composite material of claim 1, wherein the nanoparticles have an average particle size from about 5 nm to about 300 nm.

8. The composite material of claim 1, wherein the nanoparticles have an average particle size from about 5 nm to about 100 nm.

9. The composite material of claim 1, further comprising a thermoplastic resin, wherein the rubber-modified graft copolymer and the metal (oxide) nanoparticles are dispersed in a matrix of the thermoplastic resin.

10. The composite material of claim 9, wherein the thermoplastic resin comprises one or more selected from acrylonitrile-butadiene-styrene copolymer (ABS); acrylonitrile-acrylic rubber styrene copolymer resin (AAS), acrylonitrile-ethylenepropylene rubber-styrene copolymer resin, and acrylonitrile-styrene copolymer (SAN) resin.

11. The composite material of claim 9, wherein the thermoplastic resin is a SAN resin.

12. The composite material of claim 9, wherein the composite material has impact strength greater than or equal to about 21 kgf.cm/cm when a specimen of the material is tested under the standard ASTM D-256 (¼″ notched) at 23° C.

13. The composite material of claim 12, wherein the composite material has impact strength greater than or equal to about 23 kgf.cm/cm when a specimen of the material is tested under the standard ASTM D-256 (¼″ notched) at 23° C.

14. The composite material of claim 9, wherein the composite material has impact strength greater than or equal to about 40 kgf.cm/cm when a specimen of the material is tested under the standard ASTM D-256 (⅛″ notched) at 23° C.

15. The composite material of claim 14, wherein the composite material has impact strength greater than or equal to about 45 kgf.cm/cm when a specimen of the material is tested under the standard ASTM D-256 (⅛″ notched) at 23° C.

16. The composite material of claim 9, wherein the composite material has tensile strength of greater than or equal to about 501 kgf/cm² when a specimen of the material is tested under the standard ASTM D638 (5 mm/min).

17. The composite material of claim 16, wherein the composite material has tensile strength of greater than or equal to about 525 kgf/cm² when a specimen of the material is tested under the standard ASTM D638 (5 mm/min).

18. The composite material of claim 17, wherein the composite material has tensile strength of greater than or equal to about 530 kgf/cm² when a specimen of the material is tested under the standard ASTM D638 (5 mm/min).

19. The composite material of claim 9, wherein the composite material has flexural modulus of greater than or equal to about 24200 Kgf/cm² when a specimen of the material is tested under the standard ASTM D790 (¼″).

20. The composite material of claim 19, wherein the composite material has flexural modulus of greater than or equal to about 25100 Kgf/cm² when a specimen of the material is tested under the standard ASTM D790 (¼″).

21. The composite material of claim 20, wherein the composite material has flexural modulus of greater than or equal to about 25500 Kgf/cm² when a specimen of the material is tested under the standard ASTM D790 (¼″).

22. The composite material of claim 9, wherein the composite material has Heat Distortion Temperature of greater than or equal to about 90° C. when a specimen of the material is tested under the standard ASTM D648 (¼″, 120° C./hr) under 18.5 kgf/cm² load.

23. The composite material of claim 22, wherein the composite material has Heat Distortion Temperature of greater than or equal to about 91° C. when a specimen of the material is tested under the standard ASTM D648 (¼″, 120° C./hr) under 18.5 kgf/cm² load.

24. A molded article comprising the composite material of claim 9.

25. An electronic device comprising the composite material of claim 9.

26. A method of preparing a nanocomposite material comprising:
providing a rubber-modified graft copolymer;
providing colloidal metal (oxide) nanoparticles;
adsorbing the colloidal metal (oxide) nanoparticles on a surface of the rubber-modified graft copolymer to provide a nanoparticle/graft copolymer latex.

27. The method of claim 26, wherein the rubber-modified graft copolymer and the colloidal metal (oxide) nanoparticles are mixed by in-situ stirring.

28. The method of claim 26, further comprising:
dehydrating the nanoparticle/graft copolymer latex; and
drying the nanoparticle/graft copolymer latex.

29. The method of claim 26, further comprising:
agglomerating the nanoparticle/graft copolymer latex;
dehydrating the nanoparticle/graft copolymer latex; and
drying the nanoparticle/graft copolymer latex.
